(19) United States
(12) Patent Application Publication
(10) Pub. No.: US 2015/0120499 A1
(43) Pub. Date: Apr. 30, 2015

(54) METHOD AND A DEVICE FOR ALLOWING CHARGING OF A VEHICLE DRIVER

(71) Applicant: TELEFONAKTIEBOLAGET L M ERICSSON (PUL), Stockholm (SE)

(72) Inventors: Matthew John LAWRENSON, Lausanne (CH); Julian Charles Nolan, Lausanne (CH)

(73) Assignee: TELEFONAKTIEBOLAGET L M ERICSSON (PUL), Stockholm (SE)

(21) Appl. No.: 14/066,391

(22) Filed: Oct. 29, 2013

Related U.S. Application Data
(63) Continuation of application No. PCT/EP2013/072641, filed on Oct. 29, 2013.

(51) Int. Cl. G06Q 30/06; B60L 11/18

(52) U.S. Cl. CPC G06Q 30/0609; B60L 11/1848
USPC 705/26.35

(57) ABSTRACT

A method performed in a managing device for managing charging of an electrical vehicle, the method comprising the steps of retrieving (S2) information on behavior of a counterpart and/or the relationship between a user of the managing device and the counterpart, and comparing (S3) the information to a predetermined set of behavior and relationship scenarios pre-set to the managing device, as well as selecting (S4) an action to be performed by the managing device or the user of the managing device based on which behavior and relationship scenario the information matches or if a match is lacking.

### TECHNICAL FIELD

The present disclosure relates to a method performed in a managing device for managing charging of an electrical vehicle. The present disclosure relates also to a managing device for managing charging of an electrical vehicle.

### BACKGROUND

Electrical vehicles are becoming more and more common in today's society. At present there is a need to be able to charge the electrical vehicle driver at multiple places not being too spaced apart, since the operational range of a standard electrical vehicle is at times fairly limited. Furthermore, it is today also difficult to simply recharge a battery in the street because there is no possibility to recharge by use of a “spare gas can” as with for example a gasoline driven automobile. The battery needs to be either charged or replaced. Furthermore, electricity costs money so there is also a need to control that the charger of a vehicle is allowed to use the electricity to charge the vehicle at the charging place.

Herein, the phrase ‘vehicle driver’ is to be construed in a wide sense, i.e., as the driving unit which allows a vehicle and any onboard systems of the vehicle to be operational.

US 2013/046660 teaches a system in which an employee of a company may charge an electric vehicle in a charging system belonging to the employer. The system comprises an authorization module for determining whether the employer is authorized to use the charging system.

Furthermore, the document US 2010/161482 teaches an arrangement for charging electric vehicles. The arrangement comprises vehicle charging stations being arranged to identify an electric vehicle and to determine a corresponding electric power provider based on the identity of the vehicle.

### SUMMARY

Prior art systems are arranged for identifying the vehicle or driver and for adapting the vehicle charging procedure based on such identification. However, a concept of charging an electric vehicle in a manner which depends on behaviour and relationship in terms of the level or degree of “social closeness” between the vehicle operator and the person or company which provides the charging energy is unknown.

An object of the present disclosure is therefore to provide a method and device for deciding whether to allow or not to allow charging of an electrical vehicle based on behavior and relationship between a driver of an electrical vehicle and a potential charge supplier. In particular, the object is to provide a method and device for deciding whether to allow or not to allow charging of an electrical vehicle, based on decision factors such as a “relationship score” or “relationship status” for controlling a charging sequence.

Said object is obtained by a method performed in a managing device for managing charging of an electrical vehicle. The method comprises the step of retrieving information on behavior of a counterpart and/or the relationship between a user of the managing device and the counterpart. The method also comprises the step of comparing the information to a predetermined set of behavior and relationship scenarios pre-set to the managing device. The method further comprises the step of selecting an action to be performed by the managing device or the user of the managing device based on which behavior and relationship scenario the information matches, or if a match is lacking.

Thus, a concept of allowing charging of an electric vehicle in a manner which depends on a relationship in terms of the level or degree of “social closeness” between the vehicle operator the person or company which provides the charging energy is disclosed, the present technique brings a number of advantages, which advantages are detailed below.

For instance, due to the managing device and the disclosed method there is now less chance of forgetting a payment, and thus falling foul of social etiquette. Also, there is a reduced change of levying a payment in inappropriate circumstances, and thus also falling foul of social etiquette. Further, by the predetermined set of behavior and relationship scenarios pre-set to the managing device persons can be more flexible with regards to letting other persons use their charging facilities.

According to an aspect, the method further comprises the step of comparing the information with the predetermined set of behavior and relationship scenarios in a control unit.

One advantage is that this allows for an automated process for comparing.

According to an aspect, the method also comprises the step of establishing a communication link between a control unit and a database, and also the step of retrieving the information on behavior of a counterpart and/or the relationship of a user of the managing device from the database.

Thus, by the feature of the communication link between the control unit and the database, swift and secure storage and retrieval of information on the behavior of a counterpart and/or the relationship of a user of the managing device is achieved, which is an advantage.

According to an aspect, the method also comprises retrieving information on present charging cost for selecting an action to be allowed or performed by the managing device or the user of the managing device.

Retrieval of information on present charging cost, enables selection of an action to be performed with present charging cost in mind. This is advantageous since present charging cost is likely to play a major role in whether a supplier of charging energy is willing to share this charging energy with, e.g., a user of the managing device wanting to charge an electrical vehicle.

According to an aspect, the method comprises retrieving information on historical charging events and comparing the historical charging events to a predetermined set of historical charging scenarios for selecting an action to be allowed or performed by the managing device or the user of the managing device.

Since historical charging events are retrieved and used for selecting an action to be allowed or performed, the selecting of an action to be allowed can now be based on, e.g., whether a certain user already has made extensive use of a given resource, in which case social etiquette is likely to prompt said user to refrain from using said resource, at least for a pre-determined time duration. Similarly, if a given user has not made use of a given charging resource for a long period of time, the user may be allowed to do so even though not having any close relationships to the supplier of the charging resource.

According to an aspect, the method comprises establishing a communication link between a control unit and a database, and also retrieving information on historical charging events from the database.

By the feature of establishing a communication link between a control unit and a database, swift and secure retrieval of information on historical charging events from the database is achieved, which is an advantage.

According to an aspect, the method comprises determining an action to be allowed or performed by the counterpart based on the action to be performed by the managing device or the user of the managing device.

According to an aspect, the method comprises communicating the decided action(s) between the managing device and a second managing device belonging to the counterpart.

Consequently, by the feature of determining an action to be allowed or performed by the counterpart a degree of interaction between counterpart and managing device or user of the managing device is enabled. This is a benefit since it allows the counterpart to respond to actions of the managing device or the user of the managing device.

As stated above, the object of providing a device for deciding whether to allow or not to allow charging of an electrical vehicle based on behavior and relationship between a driver of an electrical vehicle and a potential charge supplier is obtained by a managing device for managing charging of an electrical vehicle. The managing device comprises a control unit and a transceiver. The control unit is connectable to a database via the transceiver or, alternatively, the control unit comprises the database. The database comprises information on the behavior of a counterpart and/or the relationship between the user of the managing device and the counterpart. Also, the control unit is configured to establish a communication link with the database, and further comprises a retrieving unit configured to retrieve information on the behavior of a counterpart and/or the relationship between the user and the counterpart. The control unit also comprises a comparing unit configured to compare the information in the database to a predetermined set of behavior and relationship scenarios pre-set to the control unit. Further, the control unit comprises a determining unit configured to determine an action to be performed by the managing device or the user of the managing device based on which behavior and relationship scenario the information matches, or if a match is lacking.

According to an aspect the control unit, via the transceiver, is connectable to a database comprising information on a present charging cost. The control unit is configured to establish a communication link with the database, and also to retrieve information on charging cost. The control unit is further configured to determine an action to be allowed or performed by the managing device or the user of the managing device.

According to an aspect the control unit, via the transceiver, is connectable to a database comprising information on historical charging events. The control unit is configured to establish a communication link with the database, and to retrieve information on the charging history and comparing the charging history with a predetermined set of historical charging scenarios, as well as to determine an action to be allowed or performed by the managing device or the user of the managing device.

According to an aspect the control unit is configured to determine an action to be allowed or performed by the counterpart based on the action to be performed by the managing device or the user of the managing device.

### BRIEF DESCRIPTION OF THE DRAWINGS

Further objects, features, and advantages of the present disclosure will appear from the following detailed description, wherein some aspects of the disclosure will be described in more detail with reference to the accompanying drawings, in which:

FIG. 1 shows a schematic overview of a vehicle driver charging system,

FIG. 2 shows a flowchart, including aspects, of method of the disclosure, and

FIG. 3 shows a flowchart of aspects of a method of the disclosure.

### DETAILED DESCRIPTION

Aspects of the present disclosure will be described more fully hereinafter with reference to the accompanying drawings. The device and method disclosed herein can, however, be realized in many different forms and should not be construed as being limited to the aspects set forth herein. Like numbers in the drawings refer to like elements throughout. The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

Electric vehicles, EVs, use energy stored in batteries to provide the energy for propulsion of the vehicle. The driving range of an EV can be on the order of approximately 100 miles of driving range. This is far less than conventional internal combustion engines which means that EV owners or operators will need to charge their vehicles more often compared to conventional internal combustion engine. Charging an EV involves connecting the battery of the vehicle to an electric energy source, such as a power outlet.

The combination of high charging frequency and the fact that charging can take place in any location is likely to give rise to scenarios such as, e.g., EVs owners charging their vehicles at friends', families' or even strangers' houses. Also, contractors are likely to want to charge their vehicles at customers' houses, and employees will likely require charging their vehicles at their place of work.

Each charging scenario brings with it a level of social etiquette, which, if not followed, may lead to social awkwardness or even conflict. ‘Charging etiquette’ is based on the relationships of the parties and may be complex to navigate, especially since it can be expected to be dynamic and not geographically constant, i.e., changing between countries and/or continents. The concept of charging etiquette will be made clear by the following detailed description.

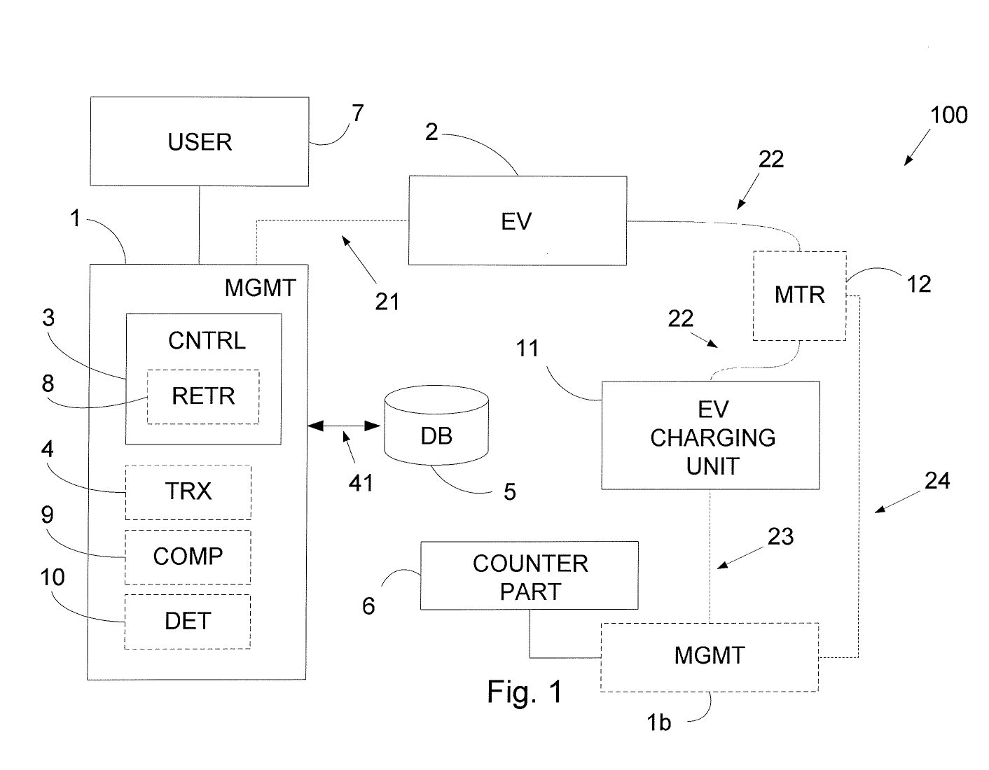

FIG. 1 shows a managing device, MGMT, 1, for managing charging of an electrical vehicle, EV, 2. The EV 2 shown in FIG. 1 is connectable 21 to the managing device 1.

The EV 2 shown in FIG. 1 is further connectable to an external energy source 11 via a charging interface 22. The external energy source is in FIG. 1 shown as an EV charging unit 11. Thus, by the charging interface 22 and the external energy source, or EV charging unit 11, the energy storage of the EV 2 can be replenished.

The charging interface 22 shown in FIG. 1 also comprises a smart meter unit, MTR, 12 adapted to determine the amount of energy passing via the charging interface 22.

The managing device 1 further comprises a control unit, CNTRL, 3, and a transceiver, TRX, 4. The control unit 3 is connectable 41 to a database, DB, 5, via the transceiver 4. Alternatively the control unit 3 comprises the database 5 in which case the transceiver is arranged for communication within the control unit 3.

The control unit 3 located in the managing device 1 comprises, according to alternatives, one or several of the following list of components:
i. A processor and memory.
ii. An algorithm stored in memory capable of processing information describing social network interactions and EV charging history, as well as categorizing the relationship and social closeness between two parties.
iii. An algorithm stored in memory capable of receiving charge history of two parties as an input and characterizing a relative usage between two parties charging systems.

The database 5 comprises information on the behavior of a counterpart 6 and/or the relationship between the user 7 of the managing device 1 and the counterpart 6.

Further, the database 5 comprises, according to aspects, the following sub-databases:
i. A first sub-database storing information organized in the following categories:
   a) Associated People and relevant personal information, such as names, social network usernames, other ‘contact tracking’ applications that can be used to gauge interaction (for example diary and geo-location applications).
   b) Equipment Identifiers.
   c) Relationship between the Parties.
   d) Past EV charging history.
ii. A second sub-database storing relationship classifications and associated information.
iii. A third sub-database storing the names of the social networks which the user 7 is a member of, or other software that can be used to gauge social interactions such as an electronic diary, a geo-location application, and including login or access details.
iv. A fourth sub-database storing commercial accounts like, e.g., money transfer services and online shops, which the user has an account with, along with details needed to access said accounts.

The managing device 1b being associated with the counterpart 6, as indicated in FIG. 1, is according to an alternative further connectable 24 to a, or comprising a smart meter unit, MTR, 12, adapted to measure or otherwise determine the amount of energy being supplied or withdrawn via a charging interface 22 of the system 100.

In order to allow information exchange between control unit 3 and database 5, the control unit 3 is configured to establish a communication link 41 with the database 5. Towards this end, the control unit 3 also comprises a retrieving unit, RETR, 8, configured to retrieve information on the behavior of a counterpart 6 and/or the relationship between the user 7 and counterpart 6.

According to alternatives, the communication link 41 can be established via wireless or wire-line connection, via the Internet, or via an ad-hoc network.

The control unit 3 also comprises a comparing unit, COMP, 9, configured to compare the retrieved information from the database 5 with a predetermined set of behavior and relationship scenarios pre-set to the control unit 3. In a preferred implementation of the control unit 3, said set of behavior and relationship scenarios are downloaded to the control unit 3 prior to making the charging system 100 operational.

The control unit 3 also comprises a determining unit, DET, 10, configured to determine an action to be performed by the managing device 1, or the user 7 of the managing device 1, based on which behavior and relationship scenario the information matches or if a match is lacking.

The function of the control unit 3 and its comprised components will be further described below through a series of illuminating examples.

The managing device 1b is, according to one alternative, comprised in or connectable 23 to the EV charging unit 11, and according to another, second, alternative comprised in or connectable 21 to the EV 2.

According to an aspect, the control unit 3 is connectable to a database 5 via the transceiver 4. The database 5 comprises information on a present charging cost. The control unit 3 is configured to establish a communication link with the database 5, and to retrieve information on said charging cost.

According to alternatives, the communication link 41 can be established in different ways. For example, via wireless or wire-line connection, via the Internet, or via an ad-hoc network, or via storage media supplied, e.g., by the user 7 or counter-part 6.

The control unit 3 is also configured to determine an action to be allowed or performed by the managing device 1 or the user 7 of the managing device 1. Three examples of the action to be performed or allowed are given below.

According to a first example, the user 7 of the managing device 1 is a potential charge supplier and the counterpart 6 is a user of the electrical vehicle 2. The action to be performed by the managing device 1 or the user 7 of the managing device 1 is allowing charging of the electrical vehicle 2.

According to a second example, the user 7 of the managing device 1 is a user of the electrical vehicle 2, and the counterpart 6 is a potential charge supplier. The action to be performed by the managing device 1 or the user 7 of the managing device 1 is the accepting of terms for charging.

According to a third example, the action to be performed by the managing device 1 or the user 7 of the managing device 1 being compensation or gratitude to the potential charge supplier.

Also, the control unit 3 is according to one aspect is configured to determine an action to be allowed or performed by the counterpart 6 based on the action to be performed by the managing device 1 or the user 7 of the managing device 1. Thus, a way of interaction between the user 7 and the counter-part 6 is provided for. For example, in case a user 7 does not follow social charging etiquette as interpreted by the counter-part 6, the counter-part 6 may respond by not allowing charging of the EV 2.

According to an aspect, the control unit 3 is connectable 41, via the transceiver 4, to a database 5 comprising information on historical charging events. The control unit 3 is configured to establish a communication link with the database 5, and is also configured to retrieve information on the charging history. The control unit 3 is further arranged for comparing said charging history to a predetermined set of historical charging scenarios, as well as being configured to determine an action to be allowed or performed by the managing device 1 or the user 7 of the managing device 1.

Since historical charging events are retrieved and used for selecting an action to be allowed or performed, the selecting of an action to be allowed can now be based on, e.g., whether a certain user 7 already has made extensive use of a given resource, in which case social etiquette is likely to prompt said user to refrain from using said resource, at least for a pre-determined time duration. Similarly, if a given user 7 has not made use of a given charging resource for a long period of time, the user may be allowed to do so even though not having any close relationships to the supplier of the charging resource. In order to better illuminate above mentioned aspects of the present teaching, and explain how the device described in connection to FIG. 1 may be put to use in practice, an example charging scenario will now be described.

Consider a first person, a user or “charge receiver” visiting a second person, a counterpart or a “charge supplier”, at their residence. The charge supplier being in possession of an energy source capable of charging an EV of the first person, and the charge receiver having need of charging an EV. Decisions likely to be made at this time include:
1. The charge supplier deciding whether or not to demand compensation from the charge receiver for charging the EV.
2. The charge receiver deciding whether or not to offer compensation (potentially in addition to any demanded compensation from the charge supplier) to the charge supplier.

Both these decisions will be based on interpretation of the above mentioned charging etiquette, which decisions are according to this example in turn based at least partly on the following ‘decision factors’:
1. The relationship to the other party, and depending on this relationship potentially also
2. the cost of supplying the energy, and/or,
3. the previous charging history of the charge receiver and the charge supplier.

The relationship to the other party is according to this example assessed via social network interactions, stored records (address book etc.), and previous social contacts.

The cost of supplying the energy is according to this example assessed by knowing the number of energy units provided, measured by a meter within the system, and connecting to a database to find the cost per energy unit.

The previous charging history is according to this example known by maintaining a database, which database is arranged to record all charging interactions.

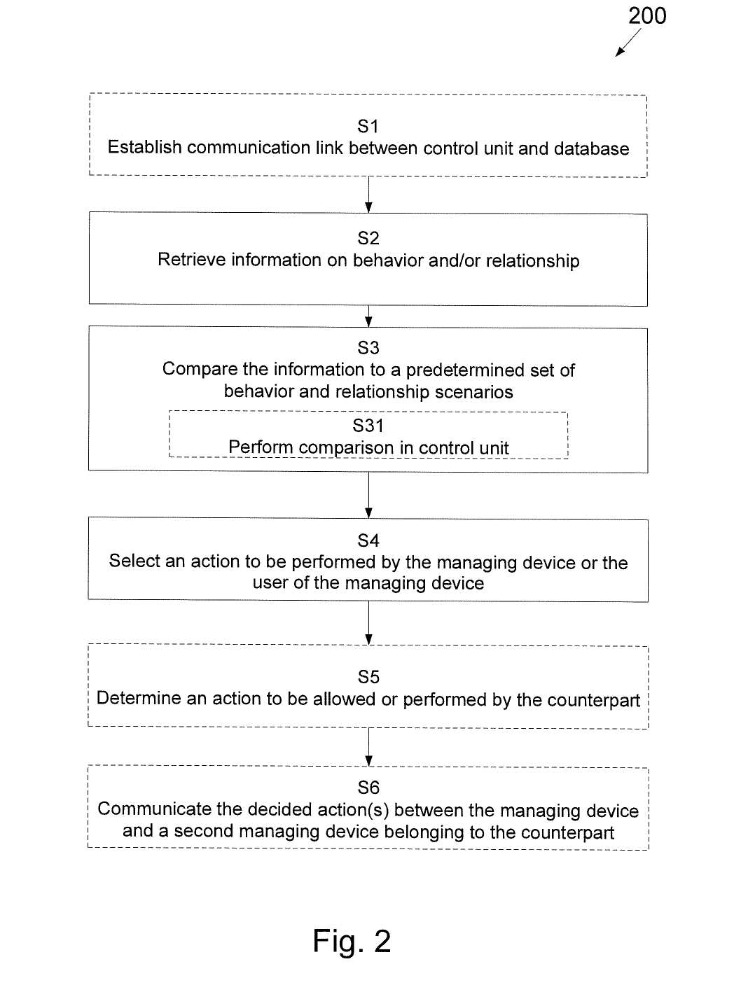

FIG. 2 shows a flowchart of a method 200 performed in a managing device 1 for managing charging of an electrical vehicle 2. The method 200 comprises the step of retrieving S2 information on behavior of a counterpart 6 and/or the relationship between a user 7 of the managing device 1 and the counterpart 6.

By the step of retrieving S2, the information needed to gauge the level or degree of “social closeness” between the party in need of charging and the person or company which provides the charging energy is collected, allowing the determining of social closeness.

The method 200 also comprises the step of comparing S3 the information to a predetermined set of behavior and relationship scenarios which are pre-set to the managing device 1, and also the step of selecting S4 an action to be performed by the managing device 1 or the user 7 of the managing device 1 based on which behavior and relationship scenario the information matches or if a match is lacking.

Thus, based on the retrieved information, a selecting S4 of an action to be performed by the managing device 1 or the user 7 of the managing device 1 is determined.

According to an aspect, the method 200 further comprises the step of comparing S31 the information to the predetermined set of behavior and relationship scenarios in a control unit 3.

According to an aspect, the method 200 comprises the step of determining S5 an action to be allowed or performed by the counterpart 6 based on the action to be performed by the managing device 1 or the user 7 of the managing device 1.

According to an aspect, the user 7 of the managing device 1 is a potential charge supplier and the counterpart 6 is a user 7 of the electrical vehicle 2, and the action to be performed by the managing device 1 or the user 7 of the managing device 1 is allowing charging of the electrical vehicle 2.

According to an aspect, the user 7 of the managing device 1 is a user 7 of the electrical vehicle 2 and the counterpart 6 is a potential charge supplier, and the action to be performed by the managing device 1 or the user 7 of the managing device 1 is accepting terms for charging.

According to an aspect, the action to be performed by the managing device 1 or the user 7 of the managing device 1 is compensation or gratitude to the potential charge supplier.

According to an aspect, the method 200 further comprises the step of communicating S6 the decided action(s) between the managing device 1 and a second managing device 1b belonging to the counterpart 6.

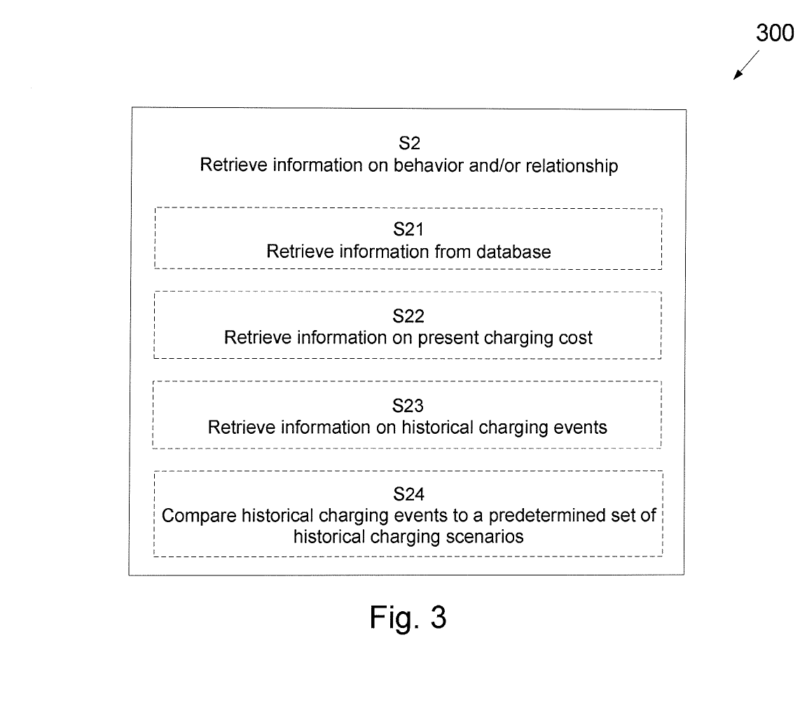

FIG. 3 shows a flowchart of aspects of the disclosed method 200, in particular aspects of the step of retrieving S2 information on behavior of a counterpart 6 and/or the relationship between a user 7 of the managing device 1 and the counterpart 6.

According to an aspect, the method 200, 300, comprises the step of establishing S1 a communication link between the control unit 3 and the database 5, and also retrieving S21 the information on the behavior of a counterpart and/or the relationship of a user of the managing device 1 from the database.

According to one aspect said communication link comprises a wireless communication link. According to one aspect said communication link comprises a wire line communication link. According to one aspect said communication link comprises a communication link sharing the same interface as the charging energy from the charging energy source to the electrical vehicle, wherein the communication data is overloaded on the charging energy flow.

According to an aspect, the method 200, 300, further comprises the step of retrieving S22 information on present charging cost for selecting an action to be allowed or performed by the managing device 1 or the user 7 of the managing device 1.

According to an aspect, the method 200, 300, also comprises the step of establishing 51 a communication link between a control unit 3 and a database 5, and retrieving S22 information on present charging cost from the database 5.

According to an aspect, the method 200, 300, further comprises the step of retrieving S23 information on historical charging events and comparing S24 the historical charging events to a predetermined set of historical charging scenarios for selecting an action to be allowed or performed by the managing device 1 or the user 7 of the managing device 1.

According to an aspect, the method 200, 300, also comprises the steps of establishing Si a communication link between the control unit 3 and the database 5, and retrieving S23 information on historical charging events from the database.

In order to better illuminate aspects of the disclosed method, an example will now be given. In this example, the control unit 3 first accesses a set of social networks of the user 7 by using login credentials stored and retrieved from the database 5.

The control unit 3 first checks each social network for connections between the user 7 and counterpart 6. If a connection is found, then a magnitude of association is assessed, which magnitude comprises the stated relationship within the social network, for example close friend, friend, colleague, and the number of interactions, e.g., messages, ‘likes’, posts on the charge providers' social network made by the charge receiver, and similar.

A scoring method, e.g., a ‘like’ may equal 1 point, a message sent only to a given person may equal 5 points is according to an alternative pre-defined and used for assessing magnitude.

The type of association is also assessed, for example by considering the language used, e.g., friendly or unfriendly.

An overall ‘relationship score’ is then found by taking into account the magnitude of association and type of association, according to an aspect by using the calculation relationship score=magnitude of interaction*type of interaction.

This relationship score is then translated to a relationship classification, preferably by using a lookup table.

In order to further illuminate aspects of the disclosed method, a second example will now be given. In this example the control unit 3 first accesses the database 5. The control unit 3 then sums the usage of both parties energy supply to charge the other person's EV. Examples of metrics that are used include: the number of times the EV has been charged and the total amount of energy transferred. A value “Charging Balance” is then calculated using these two values. Alternatives of how this is done include:
a) A ratio: e.g., the total number of times a user's EV has been charged at the house of the counterpart divided by the total number of times the EV of the counterpart has been charged at the user's house.
b) A difference: e.g., the total amount the user has supplied to the counterpart subtracted by the total amount of energy the counterpart has supplied to the user.

In order to even further illuminate aspects of the disclosed method, a third example will now be given. In this example the determined action is a payment. Here it is assumed an action of payment has been determined where the charge supplier requests payment from the charge receiver.

The user 7 first adds details of money transfer services to the database.

At run-time the control unit 3 has access to required variables, i.e., relationship classification, number of energy units transferred, and typical cost of an energy unit.

On completion of charge the control unit 3 triggers a payment via an internet payment service using information and scripts obtained from the database.

The control unit 3 uses the selected payment service to process a payment for the amount of a determined energy cost.

In a fourth example the determined action is also payment, but here it is assumed an action has been determined where the charge receiver offers a gift to the charge supplier.

The user 7 adds commercial businesses, e.g., shops, restaurants, to the database 5.

Payment processes are also added to the database 5 for each business in the form of a script, example processes include:
i. Accounts are set up with pre-approved purchases of certain items (e.g. gift vouchers) up to a certain value and number.
ii. Accounts are set up with payment that needs to be approved at the time of issue.

The control unit 3 sets a “Gift Value” as being the same amount as the cost of the energy supplied

The control unit 3 assesses the charge supplier's social network activity and determines:
i. If any preference for a shop, brand or item exists.
ii. If a preference for an activity can be associated with a shop, brand or item.

Where a preference for a brand or item exists the control unit 3 executes a script to search the shops listed in the database to see;
i. If a brand; whether there are any items of that brand are sold at that shop where the price matches the Gift Value.
ii. If an item; whether it is sold there, and whether the price matches the Gift Value.

When an item is found the control unit 3 triggers a purchase via an Internet payment service using information and script obtained from the database.

According to an alternative multiple items are found that match the criteria and are ranked via a pre-determined criteria.

According to an alternative a message is provided to the store to include in the purchase delivery.

According to an alternative a social network message is sent by the charge receiver thanking the charge provider.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

1. A method performed in a managing device for managing charging of an electrical vehicle, the method comprising:
retrieving information on one or more of a behavior of a counterpart and a relationship between a user of the managing device and the counterpart;
comparing the information with a predetermined set of behavior and relationship scenarios pre-set to the managing device; and
selecting an action to be performed by the managing device or the user of the managing device based on which behavior and relationship scenario the information matches or if a match is lacking.

2. A method according to claim 1, further comprising:
comparing the information with the predetermined set of behavior and relationship scenarios in a control unit.

3. A method according to claim 1, further comprising:
establishing a communication link between a control unit and a database; and
retrieving the information on one or more of the behavior of a counterpart and the relationship of a user of the managing device from the database.

4. A method according to claim 1, further comprising:
retrieving information on present charging cost for selecting an action to be allowed or performed by the managing device or the user of the managing device.

5. A method according to claim 4, further comprising:
establishing a communication link between a control unit and a database; and
retrieving information on present charging cost from the database.

6. A method according to claim 1, further comprising:
retrieving information on historical charging events and comparing the historical charging events with a predetermined set of historical charging scenarios for selecting an action to be allowed or performed by the managing device or the user of the managing device.

7. A method according to claim 6, further comprising:
establishing a communication link between a control unit and a database; and
retrieving information on historical charging events from the database.

8. A method according to claim 1, further comprising:
determining an action to be allowed or performed by the counterpart based on the action to be performed by the managing device or the user of the managing device.

9. A method according to claim 1, wherein the user of the managing device is a potential charge supplier and the counterpart is a user of the electrical vehicle, wherein the action to be performed by the managing device or the user of the managing device is allowing charging of the electrical vehicle.

10. A method according to claim 1, wherein the user of the managing device is a user of the electrical vehicle and the counterpart is a potential charge supplier, wherein the action to be performed by the managing device or the user of the managing device includes accepting terms for charging.

11. A method according to claim 10, wherein the action to be performed by the managing device or the user of the managing device includes compensation or gratitude to the potential charge supplier.

12. A method according to claim 1, further comprising:
communicating the selected action between the managing device and a second managing device belonging to the counterpart.

13. A managing device for managing charging of an electrical vehicle, the managing device comprising a control unit and a transceiver, wherein the control unit is connectable to a database via the transceiver or comprises the database, and wherein the database comprises information on one or more of the behavior of a counterpart and the relationship between the user of the managing device and the counterpart, wherein:
the control unit is configured to establish a communication link with the database;
the control unit comprises a retrieving unit configured to retrieve information on one or more of the behavior of a counterpart and the relationship between the user and counterpart;
the control unit comprises a comparing unit configured to compare the information in the database with a predetermined set of behavior and relationship scenarios pre-set to the control unit; and
the control unit comprises a determining unit configured to determine an action to be performed by the managing device or the user of the managing device based on which behavior and relationship scenario the information matches or if a match is lacking.

14. A managing device according to claim 13, wherein the control unit via the transceiver is connectable to a database comprising information on a present charging cost, wherein the control unit is configured to establish a communication link with the database, wherein the control unit is configured to retrieve information on charging cost and is configured to determine an action to be allowed or performed by the managing device or the user of the managing device.

15. A managing device according to claim 13, wherein the control unit via the transceiver is connectable to a database comprising information on historical charging events, wherein the control unit is configured to establish a communication link with the database, wherein the control unit is configured to retrieve information on the charging history and compare the charging history with a predetermined set of historical charging scenarios and is configured to determine an action to be allowed or performed by the managing device or the user of the managing device.

16. A managing device according to claim 13, wherein the control unit is configured to determine an action to be allowed or performed by the counterpart based on the action to be performed by the managing device or the user of the managing device.

17. A managing device according to claim 13, wherein the user of the managing device is a potential charge supplier and the counterpart is a user of the electrical vehicle, wherein the action to be performed by the managing device or the user of the managing device is allowing charging of the electrical vehicle.

18. A managing device according to claim 13, wherein the user of the managing device is a user of the electrical vehicle and the counterpart is a potential charge supplier, wherein the action to be performed by the managing device or the user of the managing device includes accepting terms for charging.

19. A managing device according to claim 18, wherein the action to be performed by the managing device or the user of the managing device includes compensation or gratitude to the potential charge supplier.
